(19) United States
(12) Patent Application Publication
(10) Pub. No.: US 2022/0003554 A1
(43) Pub. Date: Jan. 6, 2022

(54) SHIP MOVEMENT LEARNING METHOD, SHIP MOVEMENT LEARNING SYSTEM, SERVICE CONDITION ESTIMATION METHOD, AND SERVICE CONDITION ESTIMATION SYSTEM

(71) Applicant: NEC Corporation, Minato-ku, Tokyo (JP)

(72) Inventor: Kenta SENZAKI, Tokyo (JP)

(73) Assignee: NEC Corporation, Minato-ku, Tokyo (JP)

(21) Appl. No.: 17/282,136

(22) PCT Filed: Oct. 11, 2018
(86) PCT No.: PCT/JP2018/037969

§ 371 Date: Apr. 1, 2021

(51) Int. Cl. G01C 21/20; G06N 20/00; G08G 3/02; G01C 21/22

(52) U.S. Cl. CPC G01C 21/203; G01C 21/22; G08G 3/02; G06N 20/00

(57) ABSTRACT

To stably estimate a service condition of a ship of interest at each time from a time-series position information of the ship, the service condition estimation device 20 includes service condition estimation means 21 which estimates a service condition of the ship using one or more parameters generated by learning of the ship movement learning device 10. The ship movement learning device 10 includes track pattern generation means which generates a track pattern on the basis of time-series position information and speed information of a ship, and pattern learning means which learns a ship movement on the basis of a relationship between the track pattern and the service condition of the ship.

### TECHNICAL FIELD

The present invention relates to a service condition estimation method and a service condition estimation device for estimating a service condition, and a ship movement learning method and a ship movement learning device for learning ship movement for the service condition estimation method and the ship movement learning device.

### BACKGROUND ART

In recent years, environmental destruction and resource depletion due to illegal fishing has become a global problem. The Automatic Identification System (AIS) has been attracting attention as a means to deter illegal fishing. The AIS is a system for intercommunicating information such as an identification code, a type, a position, a course, a speed, service situation (also called service condition) and so on of a ship between ships and between a ship and a ground base station.

Codes that indicate a service condition include codes that indicate a fishing, in addition to codes that are sailing, anchored, and moored. When the AIS is operated correctly, it is expected to provide information on the movement of individual fishing ships and also on the actual state of fishing in a predetermined area as a whole.

There are two types of AIS equipped with a ship: Class A and Class B (also called a simple AIS). Most fishing ships are equipped with the AIS of Class B. In Class B, a service condition code is transmitted. In Class A, a service condition code is transmitted, but a service condition is manually entered into the system by a crew. Therefore, there is a possibility of altering a service condition.

Non-patent literature 1 discloses a method for discriminating between fishing and non-fishing ship movement using data that can be transmitted by the simple AIS and is difficult to alter. Specifically, in the method described in non-patent literature 1, a track pattern (ship track pattern) is generated from the time-series position information of a ship. More specifically, a track image is generated by connecting discrete AIS data points by lines. On the basis of the track patterns, fishing and non-fishing ship movements are discriminated. Since a fishing ship may show a distinctive track pattern, the binary discrimination between fishing and non-fishing movements is performed with highly accurate. In addition, a neural network learns from a large number of generated track images.

### CITATION LIST

### Patent Literature

Patent Literature 1: Japanese Patent Application Laid-Open No. 2005-96674

### Non-Patent Literature

Non-patent Literature 1: Xiang Jiang, Daniel L. Silver, Baifan Hu, Erico N. de Souza, Stan Matwin: “Fishing Activity Detection from AIS Data Using Autoencoders” Canadian Conference on AI 2016: pp. 33-39

### SUMMARY OF INVENTION

### Technical Problem

The ship movement analysis method described in the non-patent literature 1 discriminates between fishing and non-fishing ship movements using only the information of track patterns. Therefore, it is not possible to discriminate with high accuracy a movement of a fishing ship that presents a track pattern similar to that of a normal ship. In addition, the ship movement that can be discriminated is binary that is fishing or other. It is not possible to estimate the detailed service condition (for example, fishing species). Accordingly, the ship movement analysis method as described in the non-patent literature 1 has a problem that it cannot stably estimate what kind of condition a ship is in among various service conditions.

Patent literature 1 describes a method of determining a ship to be suspicious by obtaining a track pattern of the ship, comparing the obtained track pattern with pre-registered suspicious movement patterns, and determining that the ship is suspicious when the track pattern and one of the suspicious movement patterns match or are similar.

However, like the method described in non-patent literature 1, the method described in patent literature 1 is only a binary discrimination method to determine whether a ship is a general ship (normal ship) or a suspicious ship. In other words, it is not possible to stably estimate which of the various service conditions a ship is in.

It is an object of the present invention to provide a service condition estimation method and a service condition estimation device that can stably estimate a service condition of a ship of interest at each time.

### Solution to Problem

A ship movement learning method according to the present invention generates a track pattern on the basis of time-series position information and speed information of a ship, and learns a ship movement on the basis of a relationship between the track pattern and a service condition of the ship.

A service condition estimation method according to the present invention estimates a service condition of the ship using one or more parameters generated by learning of the ship movement learning method.

A ship movement learning device according to the present invention includes track pattern generation means for generating a track pattern on the basis of time-series position information and speed information of a ship, and pattern learning means for learning a ship movement on the basis of a relationship between the track pattern and a service condition of the ship.

A service condition estimation device according to the present invention includes service condition estimation means for estimating a service condition of the ship using one or more parameters generated by learning of the ship movement learning device.

A ship movement learning program according to the present invention, causing a computer to execute a process of generating a track pattern on the basis of time-series position information and speed information of a ship, and a process of learning a ship movement on the basis of a relationship between the track pattern and a service condition of the ship.

A service condition estimation program according to the present invention, causing a computer to execute estimating a service condition of the ship using one or more parameters generated by learning based on a relationship between a track pattern generated on the basis of time-series position information and speed information of a ship, and the service condition of the ship.

### Advantageous Effects of Invention

According to the present invention, it is possible to stably estimate a service condition of a ship of interest at each time from a time-series position information of the ship.

### BRIEF DESCRIPTION OF DRAWINGS

FIG. 1 It depicts a block diagram showing a configuration example of a ship movement learning device.

FIG. 2 It depicts a flowchart showing a process of generating a track pattern image using position information data and speed information data.

FIG. 3A It depicts an explanatory diagram showing an example of how a track pattern image is generated.

FIG. 3B It depicts an explanatory diagram showing an example of how a track pattern image is generated.

FIG. 3C It depicts an explanatory diagram showing an example of how a track pattern image is generated.

FIG. 4 It depicts a flowchart showing the process of determining a track drawing method on the basis of the speed information and the process of setting the labels corresponding to the track pattern images.

FIG. 5 It depicts a block diagram showing a configuration example of the service condition estimation device in the first example embodiment.

FIG. 6 It depicts a flowchart showing the operation of the service condition estimation device in the first example embodiment.

FIG. 7 It depicts a block diagram showing another configuration example of a ship movement learning device.

FIG. 8 It depicts a flowchart showing the process of a track pattern generation unit and an acceleration calculation unit.

FIG. 9 It depicts a block diagram showing a configuration example of the service condition estimation device in the second example embodiment.

FIG. 10 It depicts a flowchart showing the operation of the service condition estimation device in the second example embodiment.

FIG. 11 It depicts a block diagram showing an example of a computer with a CPU.

FIG. 12 It depicts a block diagram showing the main part of the ship movement learning device.

FIG. 13 It depicts a block diagram showing the main part of the service condition estimation device.

### DESCRIPTION OF EMBODIMENTS

Hereinafter, example embodiments of the present invention are described with reference to the drawings.

### Example Embodiment 1

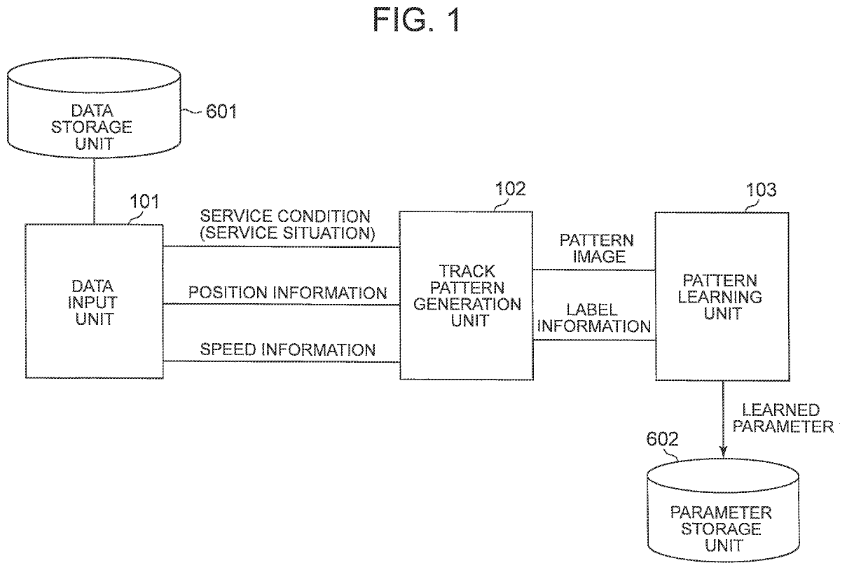

FIG. 1 is a block diagram showing a configuration example of a ship movement learning device for creating one or more parameters used by a service condition estimation device (ship movement estimation device). The ship movement learning device may be incorporated into a service condition estimation device. Alternatively, the ship movement learning device may be independent of a service condition estimation device.

The ship movement learning device illustrated in FIG. 1 has a data input unit 101, a track pattern generation unit 102, a pattern learning unit 103, a data storage unit 601, and a parameter storage unit 602.

The data storage unit 601 is a database in which service information including information on the service condition (service situation) of a ship is stored. Specifically, the data storage unit 601 is realized by a storage medium such as a hard disk or a memory card that holds service information of a ship, or a network to which a storage medium is connected. Namely, the data storage unit 601 stores or transmits service information of a ship. When the service information is transmitted, the storage device (which stores the service information) existing at the transmission destination is actually equivalent to a database.

The data input unit 101 extracts, from the data storage unit 601, time-consecutive service condition data, position information data, and speed information data of each ship included in the database. The data input unit 101 outputs the extracted service condition data, the position data, and the speed data to the track pattern generation unit 102.

In general, a data acquired from a GPS (Global Positioning System) receiver orAIS includes speed information. If the data does not contain speed information, the data input unit 101 can calculate speed from a spatial distance and a temporal distance between two continuous points. The data input unit 101 can obtain the spatial distance from date and time of the data acquired at the two continuous points.

The track pattern generation unit 102 determines a drawing method (for example, a way of changing a color of the track according to the speed of the ship) on the basis of the speed information included in the data input from the data input unit 101.

In this specification, “drawing method” refers to the attributes (for example, a color, a thickness, and a line attribute) of a drawn object (point or line segment). In other words, “drawing method” includes a concept of attributes of a drawn object.

The track pattern generation unit 102 generates a track pattern image on the basis of the time-series position information included in the input data. When generating the track pattern image, the track pattern generation unit 102 interpolates between discrete position information. Then, the track pattern generation unit 102 sets the service condition corresponding to the track pattern image among the service conditions included in the data input from the data input unit 101 as a correct label for this track pattern. Furthermore, the track pattern generation unit 102 outputs the generated track pattern image and label information to the pattern learning unit 103.

The pattern learning unit 103 learns the track pattern image from the track pattern image and the label information input from the track pattern generation unit 102, and optimizes one or more parameters of a service condition classifier (service condition model) for classifying the service condition. The pattern learning unit 103 then stores the optimized one or more parameters in the parameter storage unit 602.

The parameter storage unit 602 is realized by a storage medium such as a hard disk or a memory card that holds the one or more parameters of the service condition classifier generated by the pattern learning unit 103, or a network to which a storage medium is connected. Namely, the parameter storage unit 602 stores or transmits the one or more parameters of the service condition classifier. When the one or more parameters are transmitted, the storage device (storing service information) existing at the transmission destination holds the one or more parameters.

Next, the operation of the track pattern generation unit 102 is explained in more detail.

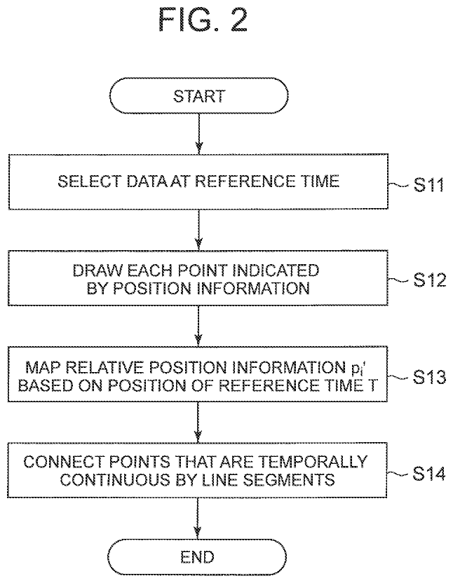

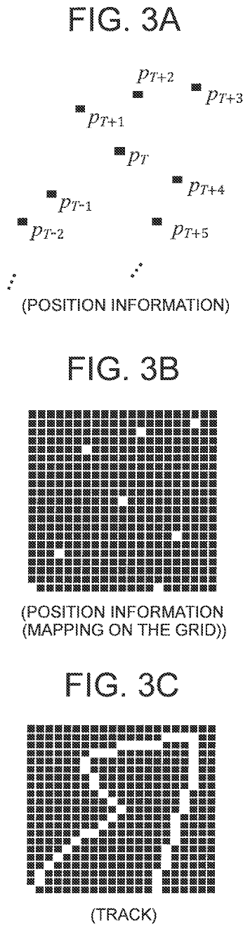

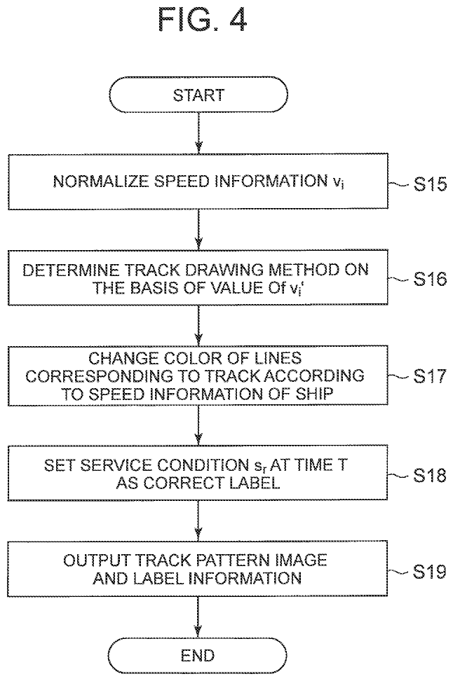

The process of generating a track pattern image from position information and speed information and the process of setting a label corresponding to the track pattern image is described, referring to flowcharts in FIGS. 2 and 4 and an explanatory diagram in FIG. 3.

FIG. 2 is a flowchart showing the process of generating a track pattern image using position information data and speed information data. FIG. 3 shows an explanatory diagram of how a track pattern image is generated. FIG. 4 is a flowchart showing the process of determining a track drawing method on the basis of speed information and the process of setting a label corresponding to the track pattern image.

The track pattern generation unit 102 selects one of the data sets of continuous time-series position information pᵢ, speed information vᵢ, and service condition sᵢ for an arbitrary time to be used as a reference (Step S11). The time to be a reference (reference time) is defined as T. In addition, pᵢ is absolute position information such as the latitude and the longitude. When the latitude is lngᵢ and the longitude is latᵢ, pᵢ is represented by the equation (1).

$$\begin{matrix}[ Math . 1 ] & \\ {p}_{i} = ( \begin{matrix}{lng}_{i} \\ {lat}_{i}\end{matrix} ) & ( 1 )\end{matrix}$$

The track pattern generation unit 102 draws each point pᵢ on the screen of the display device (not shown in FIG. 1) or in the memory in the device (Step S12). Each point pᵢ, for example, is drawn as a collection of discrete points as illustrated in FIG. 3A.

Next, the track pattern generation unit 102 calculates the relative position information pᵢ′ of the m data before and after the reference time T using the equation (2) below.

pᵢ′=round(α×pᵢ) (2)

The round(⋅) indicates a rounding process to integer values. The a is a predetermined scalar value.

Then, the track pattern generation unit 102 maps each point pᵢ′ to a section, as shown in FIG. 3B, so that the point at the reference time T is located in the center section of a plurality of sections of a predetermined size (Step S13). When the resolution of one section between grids is r, α is represented by α=1/r.

Next, the track pattern generation unit 102 connects points that are temporally continuous by line segments to generate a track pattern image as illustrated in FIG. 3C (Step S14). FIG. 3C shows an example in which each point is connected by line segments, but connecting by line segments is just one example. The track pattern generation unit 102 may use spline interpolation or other methods to make each point connected.

If the time intervals of the position information data and the speed information data are uneven, the track pattern generation unit 102 may perform a process to align the time intervals of the data for each ship to a constant value.

Next, it is explained how to generate a track pattern (track pattern image) on the basis of the speed information. The track pattern generation unit 102 normalizes the speed information vᵢ to a range of 0.0 to 1.0 by converting it as in the equation (3) using the predetermined maximum speed vₘₐₓ (Step S15). The normalized speed information is denoted as vᵢ′.

$$\begin{matrix}[ Math . 2 ] & \\ {{v}_{i}}^{′} = \{ \begin{matrix}{v}_{i} / {v}_{max} & {v}_{i} ≦ {v}_{max} \\ 1.0 & otherwise\end{matrix} & ( 3 )\end{matrix}$$

The track pattern generation unit 102 may input, for example, about 45 knots as vₘₐₓ, which is the maximum speed of a high-speed ship in practical use today. The track pattern generation unit 102 may also set vₘₐₓ to 22 knots (Japan), 24 knots (Europe), or 30 knots (USA) using the definition of the high-speed ship in each country.

The track pattern generation unit 102 determines a track drawing method on the basis of the value of vᵢ′ as illustrated in FIG. 3C (Step S16). For example, suppose that the track pattern generation unit 102 decides to use a drawing method that changes the color of the lines representing the track according to the value of vᵢ′. In order to implement such a drawing method, as an example, the track pattern generation unit 102 first maps vᵢ′ to a hue circle.

When the minimum and maximum values of vᵢ′ are mapped so that they correspond to 0 and 360 of hue values respectively, the maximum and minimum values of the speed will be continuous on the hue circle. Therefore, the track pattern generation unit 102 maps, for example, the minimum value to correspond to 0 degrees (red) and the maximum value to 240 degrees (blue). The hue Hᵢ is represented by the equation (4).

Hᵢ=(240/360)×vᵢ′ (4)

Therefore, the color in HSV (Hue Saturation Value) space, in which the speed information of the ship is reflected, is represented by the equation (5).

[Math. 3]

Cᵢ^{HSV}=[Hᵢ,1.0,1.0] (5)

The final generated color in RGB (Red Green Blue) space is represented by the equation (6).

[Math. 4]

Cᵢ^{RGB}=f_{HSV2RGB}(Cᵢ^{HSV}) (6)

It should be noted that f_{HSV2RGB}(⋅) represents a conversion function from HSV color space to RGB color space.

The track pattern generation unit 102 changes the color of the line corresponding to the track to the color represented by the equation (6) (Step S17). In this way, the track is colored according to the speed information of the ship. The track pattern generation unit 102 may use the color represented by the above equation (6) as the color at point pᵢ. However, as the color of the line segment connecting point pᵢ and point pᵢ₊₁, the track pattern generation unit 102 may calculate weighting sum for speeds so that the color between the two points changes linearly. As the color of the line segment connecting point pᵢ and point pᵢ₊₁, the track pattern generation unit 102 may simply use a color corresponding to an average value of the speed at point pᵢ and the speed at point pᵢ₊₁, or a color calculated from the speed at either one of point pᵢ and point pᵢ₊₁.

The drawing method is not limited to changing the color according to vᵢ′. For example, it is possible to use such a drawing method in which the thickness and type of lines to be drawn are changed according to vᵢ′. In the case of changing the color, a three-channel track pattern image is generated. In the case of changing the line type or thickness, a one-channel track pattern image is generated.

Then, the track pattern generation unit 102 sets the service condition sᵣ at time T as a correct answer label for the service condition indicated by the track pattern image generated as described above with time T as the center (Step S18).

The above process is repeated for an arbitrary ship and an arbitrary time to generate a large number of correctly labeled image data sets.

Then, the track pattern generation unit 102 outputs a large number of track pattern images and the correct answer labels (hereinafter referred to as label information) (Step S19).

The pattern learning unit 103 optimizes the one or more parameters of the service condition classifier by learning the track pattern images from the track pattern images and label information input from the track pattern generation unit 102.

Since there is a large amount of image data with correct labels, the pattern learning unit 103 uses a general supervised classifier. The pattern learning unit 103 can use various types of classifiers. As an example, the pattern learning unit 103 can use a Convolutional Neural Network (CNN).

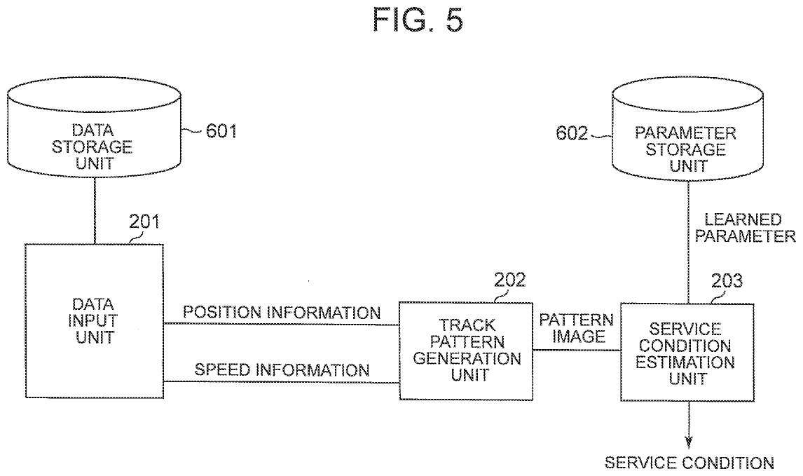

FIG. 5 shows a block diagram showing a configuration example of the service condition estimation device that estimates a service condition using one or more parameters obtained by the ship movement learning device shown in FIG. 1.

The service condition estimation device shown in FIG. 5 has a data input unit 201, a track pattern generation unit 202, a service condition estimation unit 203, a data storage unit 601, and a parameter storage unit 602.

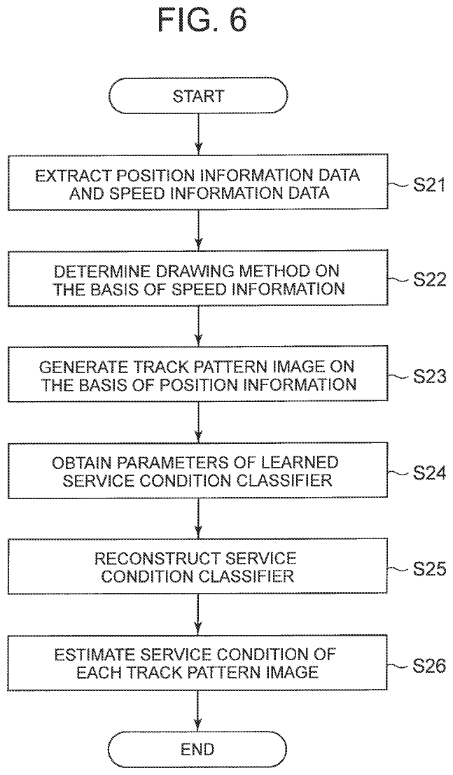

The operation of the service condition estimation device is described with reference to the flowchart in FIG. 6.

The data input unit 201 extracts the position information data and the speed information data of each ship from the data storage unit 601 where the service information is stored (Step S21). The data input unit 201 outputs the position information data and the speed information data to the track pattern generation unit 202.

The track pattern generation unit 202 determines a drawing method on the basis of the speed information included in the data input from the data input unit 201 (Step S22). The track pattern generation unit 202 generates a track pattern image on the basis of the time-series position information included in the data input (Step S23). When generating the track pattern image, the track pattern generation unit 202 interpolates between the discrete position information. The function of the track pattern generation unit 202 is the same as the function of the track pattern generation unit 102, except that it does not need to have the function of setting the label corresponding to the track pattern. Then, the track pattern generation unit 202 outputs the generated track pattern image to the service condition estimation unit 203.

The service condition estimation unit 203 obtains one or more parameters of the learned service condition classifier (trained service condition model) from the parameter storage unit 602 (Step S24). The service condition estimation unit 203 reconstructs a service condition classifier of the same configuration as the service condition classifier learned by the pattern learning unit 103 (Step S25). The service condition estimation unit 203 estimates a service condition of each track pattern image from the track pattern images input from the track pattern generation unit 202 (Step S26), and outputs the estimated service condition.

The service condition estimation device of this example embodiment superimposes (in this example embodiment, the color according to the speed information, etc., are interposed) the speed information of the ship on the track (for example, the track pattern image) to increase the amount of information on the service condition. Therefore, it is possible to stably estimate a service condition, which is difficult to classify only from the track.

### Example Embodiment 2

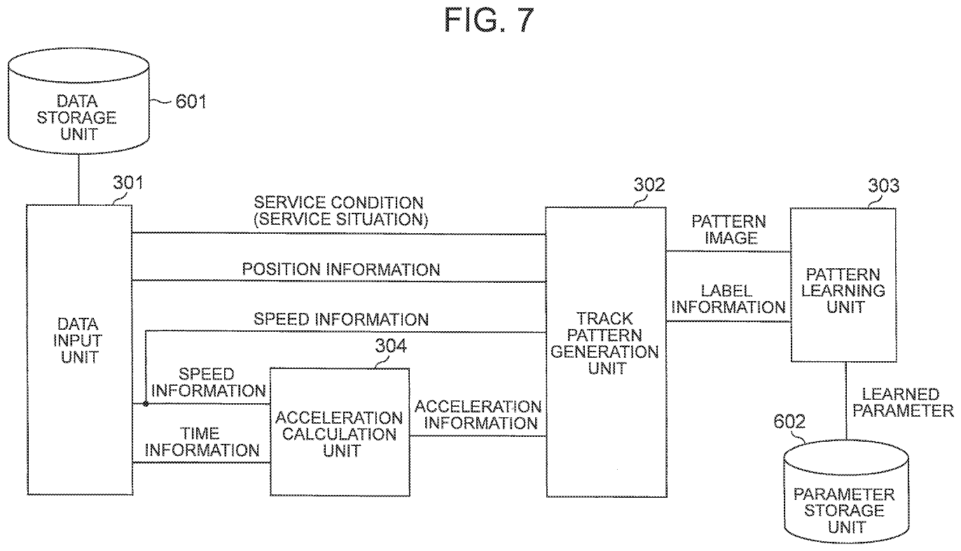

FIG. 7 is a block diagram showing another configuration example of a ship movement learning device for creating one or more parameters used by a service condition estimation device. The ship movement learning device may be incorporated into a service condition estimation device. Alternatively, the ship movement learning device may be independent of a service condition estimation device.

In the first example embodiment, the service condition estimation device increases an amount of information by superimposing speed information of a ship on the track, thereby realizing stable estimation of the service condition. In this example embodiment, the service condition estimation device uses acceleration information in addition to speed information to achieve a more stable estimation of the service condition.

The ship movement learning device of the second example embodiment illustrated in FIG. 7 has a data input unit 301, a track pattern generation unit 302, a pattern learning unit 303, an acceleration calculation unit 304, a data storage unit 601, and a parameter storage unit 602.

The data input unit 301 extracts, from the data storage unit 601 in which service information of ships is stored, the data of time-consecutive service condition, the position information, the speed information, and the time information of each ship. The data input unit 301 outputs service condition data, position information data, and speed information data to the track pattern generation unit 302. In addition, the data input unit 301 outputs the speed information data and the time information data to the acceleration calculation unit 304. In general, a data acquired from a GPS receiver or AIS includes speed information. If the data does not contain speed information, the data input unit 301 can calculate speed from a spatial distance and a temporal distance between two continuous points. The data input unit 301 can obtain the spatial distance from date and time of the data acquired at the two continuous points.

The track pattern generation unit 302 uses the position information data and speed information data input from the data input unit 301, and the acceleration information data input from the acceleration calculation unit 304. The track pattern generation unit 302 determines a drawing method (for example, a way of changing a color of the track according to the speed of the ship) on the basis of the speed information and acceleration information. The track pattern generation unit 302 generates a track pattern image on the basis of the time-series position information included in the input data. When generating the track pattern image, the track pattern generation unit 302 interpolates between discrete position information. Then, the track pattern generation unit 302 sets the service condition corresponding to the track pattern image among the service conditions included in the data input from the data input unit 301 as a correct label for this track pattern. Furthermore, the track pattern generation unit 302 outputs the generated track pattern image and label information to the pattern learning unit 303.

The pattern learning unit 303 learns the track pattern image from the track pattern image and the label information input from the track pattern generation unit 302, and optimizes one or more parameters of a service condition classifier. The pattern learning unit 303 then stores the optimized one or more parameters in the parameter storage unit 602.

The acceleration calculation unit 304 calculates acceleration from the time information data and the speed information data input from the data input unit 301. The acceleration calculation unit 304 then outputs the calculated acceleration information data (data indicating acceleration) to the track pattern generation unit 302.

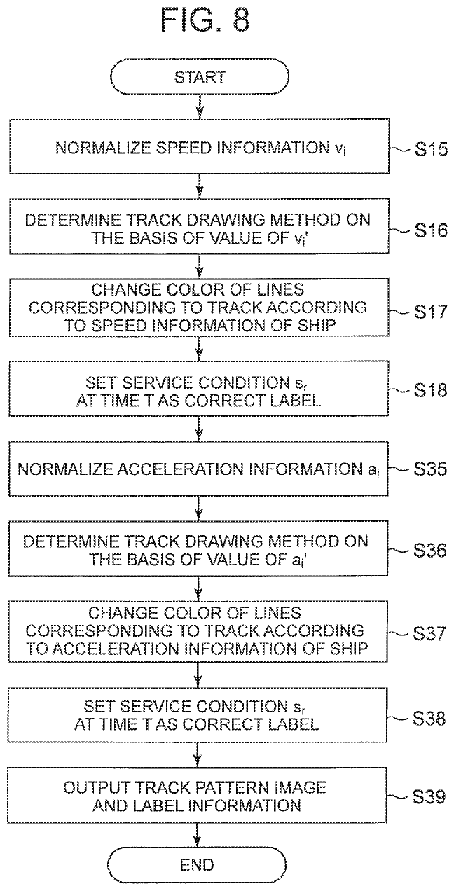

Next, the process of the track pattern generation unit 302 and the process of the acceleration calculation unit 304 are explained in more detail with reference to the flowchart in FIG. 8.

First, the process by which the acceleration calculation unit 304 calculates acceleration from time information and speed information input from the data input unit 301 is explained. The acceleration aᵢ at each time is calculated by the equation (7), using the temporally continuous speed information vᵢ and the time tᵢ at which each speed information was observed.

$$\begin{matrix}[ Math . 5 ] & \\ {a}_{i} = \frac{{v}_{i + 1} - {v}_{i}}{{t}_{i + 1} - {t}_{i}} & ( 7 )\end{matrix}$$

In other words, the acceleration calculation unit 304 calculates acceleration aᵢ using the equation (7).

Next, the process of generating a track pattern image from position information and speed information is explained.

The track pattern generation unit 302 generates track pattern images based on position information and speed information in the same way as the track pattern generation unit 102 in the first example embodiment (steps S15 to S18).

The acceleration calculation unit 304 converts the acceleration information aᵢ as in the equation (8) using the predetermined highest acceleration aₘₐₓ, and then normalizes the acceleration information aᵢ to a range of 0.0 to 1.0 (Step S35). The normalized acceleration information is denoted as aᵢ′.

$$\begin{matrix}[ Math . 6 ] & \\ {{a}_{i}}^{′} = \{ \begin{matrix}{a}_{i} / {a}_{max} & {a}_{i} ≦ {a}_{max} \\ 1.0 & otherwise\end{matrix} & ( 8 )\end{matrix}$$

It is noted that that aₘₐₓ is a predetermined value that can be adjusted by the user.

The track pattern generation unit 302 determines a track drawing method illustrated in FIG. 3C, on the basis of the value of aᵢ′ (Step S36). For example, suppose that the track pattern generation unit 302 decides to use the drawing method that changes the color of the lines in the track according to the value of aᵢ′. In order to implement such a drawing method, as an example, the track pattern generation unit 302 first maps aᵢ′ to a hue circuit.

When the minimum and maximum values of aᵢ′ are mapped so that they correspond to 0 and 360 of hue values respectively, the maximum and minimum values of the acceleration will be continuous on the hue circle. Therefore, the track pattern generation unit 302 maps, for example, the minimum value to correspond to 0 degrees (red) and the maximum value to 240 degrees (blue). The hue Hᵢ is represented by the equation (9).

Hᵢ=(240/360)×aᵢ′ (9)

Therefore, the color in HSV space, in which the speed information of the ship is reflected, is represented by the equation (10).

[Math. 7]

Cᵢ^{HSV}=[Hᵢ,1.0,1.0] (10)

The final generated color in RGB space is represented by the equation (11).

[Math. 8]

Cᵢ^{RGB}=f_{HSV2RGB}(Cᵢ^{HSV}) (11)

It should be noted that the equation (10) and the equation (11) are the same as the equation (5) and the equation (6), but unlike the equation (5), Hᵢ in the equation (10) is calculated using aᵢ′.

The track pattern generation unit 302 changes the color of the line corresponding to the track to the color represented by the equation (11) (Step S37). In this way, the track is colored according to the acceleration information of the ship. The track pattern generation unit 302 may use the color represented by the above equation (11) as the color of the line segment connecting the point pᵢ and the point pᵢ₊₁. The track pattern generation unit 302 can use the color corresponding to an average value of the acceleration at point pᵢ₋₁ and an acceleration at point pᵢ as the color at point pᵢ. The track pattern generation unit 302 may use a color calculated from the acceleration at either one of the points pᵢ₋₁ and pᵢ as the color at point pᵢ.

The drawing method is not limited to changing the color according to aᵢ′. For example, it is possible to use such a drawing method in which the thickness and type of lines to be drawn are changed according to aᵢ′. In the case of changing the color, a three-channel track pattern image is generated. In the case of changing the line type or thickness, a one-channel track pattern image is generated.

Then, the track pattern generation unit 302 sets the service condition sᵣ at time T as a correct answer label for the service condition indicated by the track pattern image generated as described above with time T as the center (Step S38).

Then, the track pattern generation unit 302 outputs a large number of track pattern images and the correct answer labels (Step S39).

Specifically, the track pattern generation unit 302 outputs two types of track pattern images, which are of the track pattern whose drawing method is determined on the basis of speed and another track pattern whose drawing method is determined on the basis of acceleration, to the pattern learning unit 303 as six-channel track pattern images.

If the drawing method for speed is different from the drawing method for acceleration, such that the determined drawing method on the basis of speed is a method using color and the determined drawing method on the basis of acceleration is a method using line thickness, the track pattern generation unit 302 outputs a three-channel track pattern image (based on speed) or a one-channel track pattern image (based on acceleration) to the pattern learning unit 303.

The pattern learning unit 303 performs the same process as the pattern learning unit 103 in the first example embodiment. That is, the pattern learning unit 303 learns the track pattern image from the track pattern images and label information input from the track pattern generation unit 302, and optimizes the one or more parameters of the service condition classifier. The pattern learning unit 303 then stores the optimized one or more parameters in the parameter storage unit 602.

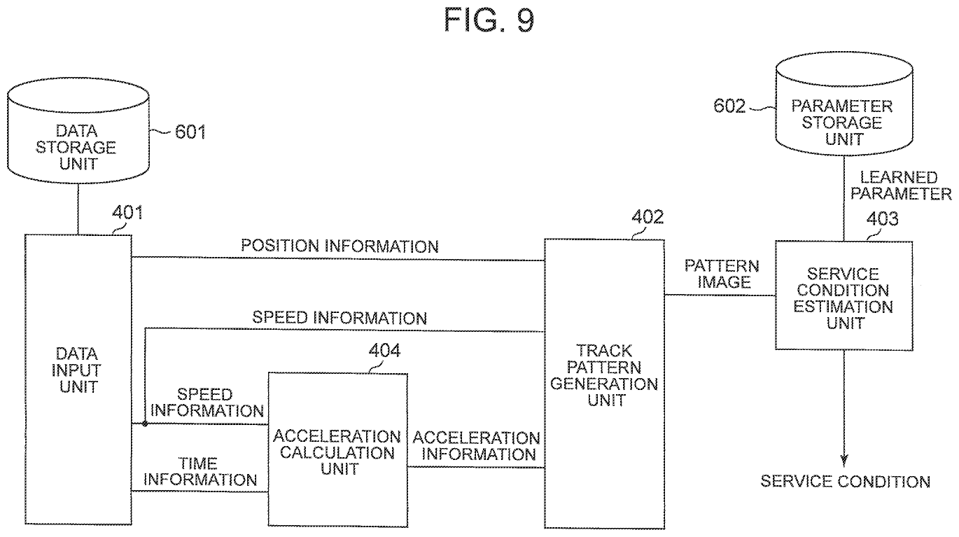

FIG. 9 shows a block diagram showing a configuration example of the service condition estimation device that estimates a service condition using the one or more parameters obtained by the ship movement learning device shown in FIG. 7.

The service condition estimation device shown in FIG. 9 has a data input unit 401, a track pattern generation unit 402, a service condition estimation unit 403, an acceleration calculation unit 404, a data storage unit 601, and a parameter storage unit 602.

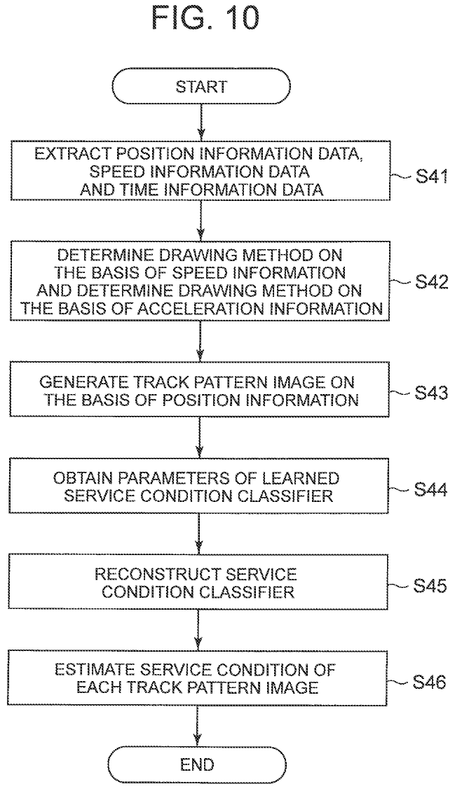

The operation of the service condition estimation device is described with reference to the flowchart in FIG. 10.

The data input unit 401 extracts the position information data, the speed information data, and the time information data of each ship from the data storage unit 601 in which the service information of the ships is stored (step S41). The data input unit 401 outputs the position information data and the speed information data to the track pattern generation unit 402. The data input unit 401 also outputs the speed information data and the time information data to the acceleration calculation unit 404.

The acceleration calculation unit 404 has the same function as that of the acceleration calculation unit 304 shown in FIG. 7. Therefore, the acceleration calculation unit 404 performs the same processing as that by the acceleration calculation unit 304 to calculate acceleration.

The track pattern generation unit 402 determines a drawing method based on the speed information and a drawing method based on the acceleration information using the speed information data input from the data input unit 401 and the acceleration information data input from the acceleration calculation unit 304 (Step S42).

The track pattern generation unit 402 generates a track pattern image on the basis of the time-series position information included in the input data (Step S43). When generating the track pattern image, the track pattern generation unit 402 interpolates between discrete position information. The function of the track pattern generation unit 402 is the same as the function of the track pattern generation unit 302, except that it does not need to have the function of setting the label corresponding to the track pattern. Then, the track pattern generation unit 402 outputs the generated track pattern image to the service condition estimation unit 403.

The service condition estimation unit 403 obtains the one or more parameters of the learned service condition classifier from the parameter storage unit 602 (Step S44). The service condition estimation unit 403 reconstructs a service condition classifier of the same configuration as the service condition classifier learned by the pattern learning unit 303 (Step S45). The service condition estimation unit 403 estimates the service condition of each track pattern image from the track pattern images input from the track pattern generation unit 402 (Step S46), and outputs the estimated service conditions.

The service condition estimation device of this example embodiment superimposes acceleration information on the track (for example, the track pattern image) in addition to the speed information of the ship (in this example embodiment, the color according to the speed information, etc., and the color according to the acceleration information, etc., are interposed) to increase the amount of information on the service condition. Therefore, it is possible to stably estimate the service condition, which is difficult to classify only from the track.

In this example embodiment, acceleration information is superimposed on the track in addition to the speed information of the ship, but only acceleration information may be superimposed on the track.

Although the components in the above example embodiments may be configured with a piece of hardware or a piece of software. Alternatively, the components may be configured with a plurality of pieces of hardware or a plurality of pieces of software. Further, part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

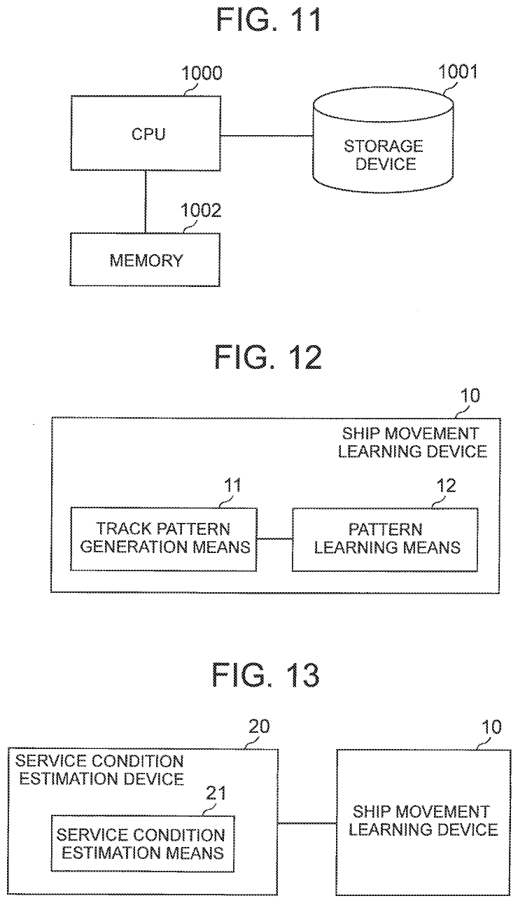

FIG. 11 shows a block diagram showing an example of the computer having a CPU. The computer is implemented in a ship movement learning device or a service condition estimation device. The CPU 1000 executes processing in accordance with a program stored in a storage device 1001 to realize the functions in the above example embodiments. When the computer is implemented in the ship movement learning device, the computer realizes the functions of the data input unit 101, 301, the track pattern generation unit 102, 302, the pattern learning unit 103, 303, and the acceleration calculation unit 304 in the ship movement learning device shown in FIGS. 1 and 7.

When the computer is implemented in the service condition estimation device, the computer realizes the functions of the data input unit 201, 401, the track pattern generation unit 202, 402, the service condition estimation unit 203, 403, and the acceleration calculation unit 404 in the service condition estimation device shown in FIGS. 5 and 9.

The data storage unit 601 and the parameter storage unit 602 may be implemented in the computer or may exist outside the computer.

The storage device 1001 is, for example, a non-transitory computer readable medium. The non-transitory computer readable medium includes various types of tangible storage media. Specific examples of the non-transitory computer readable medium include magnetic storage media (for example, flexible disk, magnetic tape, hard disk drive), magneto-optical storage media (for example, magneto-optical disc), compact disc-read only memory (CD-ROM), compact disc-recordable (CD-R), compact disc-rewritable (CD-R/W), and semiconductor memories (for example, mask ROM, programmable ROM (PROM), erasable PROM (EPROM), flash ROM).

The program may be stored in various types of transitory computer readable media. The transitory computer readable medium is supplied with the program through, for example, a wired or wireless communication channel, or, via electric signals, optical signals, or electromagnetic waves.

A memory 1002 is a storage means implemented by a random access memory (RAM), for example, and temporarily stores data when the CPU 1000 executes processing. A conceivable mode is that the program held in the storage device 1001 or in a transitory computer readable medium is transferred to the memory 1002, and the CPU 1000 executes processing on the basis of the program in the memory 1002.

FIG. 12 is a block diagram showing the main part of the ship movement learning device. The ship movement learning device 10 shown in FIG. 12 comprises track pattern generation means 11 (in the example embodiments, this is realized by the track pattern generation unit 102, 302) for generating a track pattern (for example, a track pattern image) on the basis of time-series position information and speed information of a ship, and pattern learning means 12 (in the example embodiments, this is realized by the pattern learning unit 103, 303) for learning a ship movement on the basis of a relationship between the track pattern and the service condition of the ship (for example, the one or more parameters of the service condition classifier (service condition model) for classifying the service condition with the service condition corresponding to the track pattern as a correct label are optimized).

FIG. 13 is a block diagram showing the main part of the service condition estimation device. The service condition estimation device 20 shown in FIG. 13 comprises service condition estimation means 21 (in the example embodiments, this is realized by the service condition estimation unit 203, 403) for estimating the service condition of the ship using one or more parameters generated by learning the ship movement learning device 10.

The service condition estimation device may comprise service condition estimation means for estimating the service condition of the ship by using one or more parameters generated by learning based on a relationship between the track pattern generated on the basis of the time-series position information and speed information of the ship and the service condition of the ship. The service condition estimation method may be configured to estimate the service condition of the ship by using one or more parameters generated by learning based on a relationship between the track pattern generated on the basis of the time-series position information and speed information of the ship and the service condition of the ship.

Although the invention of the present application has been described above with reference to example embodiments, the present application is not limited to the above example embodiments. Various changes can be made to the configuration and details of the present application that can be understood by those skilled in the art within the scope of the present application. As an example, the track pattern generation unit can use not only speed and acceleration, but also a rate of turn (time variation of the direction of travel) as information that can be used to determine a drawing method.

The rate of turn is included in the AIS information on service situation (service condition). When the rate of turn is used, the track pattern generation unit 102, 202, 303, 402 normalizes time-series rate of turn as in the case of using acceleration etc. When the normalized rate of turn is tr′, the track pattern generation unit maps each tr′ to a hue circle and determines a color corresponding to each tr′. Then, the track pattern generation unit colors the point pᵢ (see FIG. 3C) with the color corresponding to the tr′ at that point, for example, and colors a line segment connecting the point pᵢ and the point pᵢ₊₁ with the color corresponding to an average value of the tr′ at the point pᵢ and the tr′ at the point pᵢ₊₁, for example. The drawing method is not limited to changing the color according to tr′. For example, the thickness and type of lines to be drawn may be changed according to tr′. Furthermore, as in the case of each of the above example embodiments, the track pattern generation unit sets the service condition sᵣ at time T as a correct answer label for the service condition indicated by the track pattern image.

Apart of or all of the above example embodiments may also be described as, but not limited to, the following supplementary notes.

(Supplementary note 1) A ship movement learning method comprising:

learning a ship movement on the basis of a relationship between a track pattern (for example, a track pattern image) generated on the basis of time-series position information and speed information of a ship, and the service condition of the ship (for example, the one or more parameters of the service condition classifier (service condition model) for classifying the service condition with the service condition corresponding to the track pattern as a correct label are optimized).

(Supplemental note 2) The ship movement learning method according to Supplementary note 1, further comprising

determining a drawing method for the track pattern on the basis of the speed information.

(Supplemental note 3) The ship movement learning method according to Supplementary note 2, further comprising

determining a color of a track as a color based on the speed information.

(Supplementary note 4) The ship movement learning method according to Supplementary note 2 or 3, further comprising

determining a color of the track as a color based on a change in a speed of the ship (for example, acceleration) or a change in a direction of the ship (for example, rate of turn).

(Supplementary note 5) The ship movement learning method according to one of Supplementary notes 1 to 4, further comprising

optimizing one or more parameters of a service condition classifier for classifying the service condition by learning.

(Supplementary note 6) A service condition estimation method comprising

estimating the service condition of the ship using one or more parameters generated by learning of the ship movement learning method according to one of Supplementary notes 1 to 5.

(Supplemental note 7) A ship movement learning device comprising:

track pattern generation means for generating a track pattern on the basis of time-series position information and speed information of a ship, and

pattern learning means for learning a ship movement on the basis of a relationship between the track pattern and a service condition of the ship.

(Supplemental note 8) The ship movement learning device according to Supplementary note 7, wherein

the track pattern generation means determines a drawing method for the track pattern on the basis of the speed information.

(Supplemental note 9) The ship movement learning device according to Supplementary note 8, wherein

the track pattern generation means determines a color of a track as a color based on the speed information.

(Supplemental note 10) The ship movement learning device according to Supplementary note 8 or 9, wherein

the track pattern generation means determines a color of a track as a color based on a change in a speed of the ship or a change in a direction of the ship.

(Supplementary note 11) The ship movement learning device according to one of Supplementary notes 7 to 10, wherein

the pattern learning means optimizes one or more parameters of a service condition classifier for classifying the service conditions by learning.

(Supplementary note 12) A service condition estimation device comprising

service condition estimation means for estimating the service condition of the ship using one or more parameters generated by learning of the ship movement learning device according to one of Supplementary notes 7 to 11.

(Supplemental note 13) A ship movement learning program causing a computer to execute:

a process of generating a track pattern on the basis of time-series position information and speed information of a ship, and

a process of learning a ship movement on the basis of a relationship between the track pattern and a service condition of the ship.

(Supplemental note 14) The ship movement learning program according to Supplementary note 13, causing the computer to further execute determining a drawing method for the track pattern on the basis of the speed information.

(Supplemental note 15) The ship movement learning program according to Supplementary note 14, causing the computer to further execute

determining a color of a track as a color based on the speed information.

(Supplemental note 16) The ship movement learning program according to Supplementary note 14 or 15, causing the computer to further execute

determining a color of the track as a color based on a change in a speed of the ship or a change in a direction of the ship.

(Supplemental note 17) The ship movement learning program according to one of Supplementary notes 13 to 16, causing the computer to further execute

optimizing one or more parameters of a service condition classifier for classifying the service condition by learning.

(Supplemental note 18) A service condition estimation program comprising, causing the computer to execute:

estimating a service condition of the ship using one or more parameters generated by learning based on a relationship between a track pattern generated on the basis of time-series position information and speed information of a ship, and the service condition of the ship.

### REFERENCE SIGNS LIST

10 ship movement learning device
11 track pattern generation means
12 pattern learning means
20 service condition estimation device
21 service condition estimation means
101, 201, 301, 401 data input unit
102, 202, 302, 402 track pattern generation unit
103, 303 pattern learning unit
203, 403 service condition estimation unit
304, 404 acceleration calculation unit
601 data storage unit
602 parameter storage unit
1000 CPU
1001 storage device
1002 memory

What is claimed is:

1-18. (canceled)

19. A service condition learning method comprising:
generating a track pattern on the basis of time-series position information and speed information of a ship,
learning a ship movement on the basis of a relationship between the track pattern and a service condition of the ship, and
estimating the service condition of the ship using the one or more parameters generated by the learning.

20. The service condition learning method according to claim 19, further comprising
determining a drawing method for the track pattern on the basis of the speed information.

21. The service condition learning method according to claim 20, further comprising
determining a color of a track as a color based on the speed information.

22. The service condition learning method according to claim 20, further comprising
determining a color of the track as a color based on a change in a speed of the ship or a change in a direction of the ship.

23. The service condition learning method according to claim 19, further comprising
optimizing one or more parameters of a service condition classifier for classifying the service condition by learning.

24. A service condition learning device comprising:
a track pattern generation unit which generates a track pattern on the basis of time-series position information and speed information of a ship,
a pattern learning unit which learns a ship movement on the basis of a relationship between the track pattern and a service condition of the ship, and
a service condition estimation unit which estimates the service condition of the ship using one or more parameters generated by learning of the pattern learning unit.

25. The service condition learning device according to claim 24, wherein
the track pattern generation unit determines a drawing method for the track pattern on the basis of the speed information.

26. The service condition learning device according to claim 25, wherein
the track pattern generation unit determines a color of a track as a color based on the speed information.

27. The service condition learning device according to claim 25, wherein
the track pattern generation unit determines a color of a track as a color based on a change in a speed of the ship or a change in a direction of the ship.

28. The service condition learning device according to claim 24, wherein
the pattern learning unit optimizes one or more parameters of a service condition classifier for classifying the service conditions by learning.

29. A non-transitory computer readable recording medium storing a service condition learning program, when executed by a processor, performs:
generating a track pattern on the basis of time-series position information and speed information of a ship,
learning a ship movement on the basis of a relationship between the track pattern and a service condition of the ship, and
estimating the service condition of the ship using the one or more parameters generated by the learning.

30. The recording medium according to claim 29, wherein
when executed by the processor, the service condition learning program further performs determining a drawing method for the track pattern on the basis of the speed information.

31. The recording medium according to claim 30, wherein
when executed by the processor, the service condition learning program further performs determining a color of a track as a color based on the speed information.

32. The recording medium according to claim 30, wherein
when executed by the processor, the service condition learning program further performs determining a color of the track as a color based on a change in a speed of the ship or a change in a direction of the ship.

33. The recording medium according to one of claim 29, wherein
when executed by the processor, the service condition learning program further performs optimizing one or more parameters of a service condition classifier for classifying the service condition by learning.
